(19) United States
(12) Patent Application Publication
(10) Pub. No.: US 2004/0181885 A1
(43) Pub. Date: Sep. 23, 2004

(54) Cleaning apparatus for nozzle

(75) Inventors: Taiichiro Aoki, Kanagawa (JP); Seiji Ohishi, Kanagawa (JP)

Correspondence Address: CARRIER BLACKMAN AND ASSOCIATES, 24101 NOVI ROAD, SUITE 100, NOVI, MI, 48375

(73) Assignee: Tokyo Ohka Kogyo Co., Ltd., Kanagawa (JP)

(21) Appl. No.: 10/796,622

(22) Filed: Mar. 9, 2004

(30) Foreign Application Priority Data
Mar. 10, 2003 (JP) 2003-063560

(51) Int. Cl. B08B 1/04

(52) U.S. Cl. 15/21.1

(57) ABSTRACT

The object of the present invention is to provide a cleaning apparatus for a nozzle comprising a brush which can be moved in the vertical direction and the horizontal direction while being rotated. Specifically, the cleaning apparatus for a nozzle having a slit-like discharge opening in the lower end thereof, comprises a cleaning tank which is filled with a cleaning liquid, and a cylindrical long-length brush which is disposed within the cleaning tank so that the axis of the brush is parallel to the slit-like discharge opening, wherein the length of the long-length brush is substantially the same as the length of the nozzle, and the brush is rotatable around the axis thereof and can be reciprocated in the horizontal direction perpendicular to the axis and also in the vertical direction

### BACKGROUND OF THE INVENTION

1. Field of the Invention

The present invention relates to a cleaning apparatus for a slit nozzle which is used for applying a coating liquid in a state of having a predetermined width onto the surface of a plate-like material to be treated such as a semiconductor wafer, a glass substrate, or the like.

2. Description of the Prior Art

According to the conventional art, in order to apply a resist liquid or the like to the surface of a plate-like material to be treated such as a semiconductor wafer, a glass substrate, or the like, a coating liquid is dropped from a nozzle onto the center of the material to be treated which is mounted on a spinner, and the coating liquid is dispersed to the outside by centrifugal force which is generated by rotating the material to be treated with the spinner. However, in this method, only a small amount of coating liquid remains on the surface of the material to be treated, while almost all the liquid is dissipated and wasted.

Therefore, instead of spinner coating, a slit nozzle has been invented. The slit nozzle has an opening of a predetermined width for discharging a coating liquid, and a coating liquid is applied to the surface of the material to be treated in a state of having a predetermined width by moving the nozzle with respect to the material to be treated.

In a case where the slit nozzle having an opening of a predetermined width is used, the waste of a coating liquid can be prevented, and efficient coating can be conducted. However, since the width of the slit nozzle is great, an excessive amount of coating liquid tends to stay in the opening of the nozzle and the periphery thereof, which causes generation of foreign materials after being dried. Therefore, it is necessary to remove the coating liquid from the opening of the nozzle and the periphery thereof by conducting cleaning after coating.

In order to clean the tip end of the nozzle, various methods have been used. For example, a method has been used in which the whole tip end of the nozzle is cleaned at one time by using a cleaning apparatus having openings for discharging a cleaning liquid.

However, in a case of cleaning by means of the above-mentioned apparatus having openings for discharging a cleaning liquid, it is difficult to supply a cleaning liquid to all the openings at uniform pressure, which will prevent uniform cleaning.

Therefore, another method for cleaning a nozzle has been disclosed in which a plurality of scrubbers are provided and the nozzle is cleaned by allowing the surface of the scrubbers to come into contact with the surface to be cleaned in the various positions along the outer surface of the nozzle while the scrubbers are rotated in a cleaning liquid. Each scrubber is a brush made of bristles, and the axis is movable so as to be adapted for various kinds of nozzles.

Document 1: Japanese Patent Application Publication 2002-500097 (p 38-p 40, FIG. 9)

However, the above-mentioned method has a drawback that the position of the axis needs to be changed each time the area to be cleaned is changed because the axis of the scrubber cannot be moved during cleaning.

The present invention has been made to solve the drawback, and the object of the present invention is to provide a cleaning apparatus for a nozzle comprising a brush whose axis is movable upward and downward, and also leftward and rightward while the brush is being rotated.

### SUMMARY OF THE INVENTION

According to a first aspect of the present invention, for the purpose of overcoming the drawback mentioned above, there is provided a cleaning apparatus for a nozzle having a slit-like discharge opening in the lower end thereof, comprising a cleaning tank which is filled with a cleaning liquid, and a cylindrical long-length brush which is disposed within the cleaning tank so that the axis of the brush is parallel to the slit-like discharge opening, wherein the length of the long-length brush is substantially the same as the length of the nozzle, and the brush is rotatable around the axis thereof and can be reciprocated in the horizontal direction perpendicular to the axis and also in the vertical direction.

Since the long-length brush is moved in the vertical direction and the horizontal direction while being rotated in a state of being in contact with the lower end of the nozzle to be cleaned, it is possible to clean both side surfaces of the discharge opening of the slit nozzle as well as the discharge opening itself with the long-length brush always being in contact in the best position. Specifically, in order to clean both side surfaces of the discharge opening, the long-length brush is moved in the horizontal direction and then elevated.

Regarding the arrangement direction of the hair structure of the long-length brush, the hair structure is arranged obliquely with respect to the axis of the brush so as to be in contact with the lower end of the nozzle to be cleaned in an oblique direction. With this, the contact area of the hair structure with the portion of the nozzle to be cleaned becomes large, and thereby cleaning efficiency can be improved.

According to a second aspect of the present invention, there is provided a cleaning apparatus for a nozzle having a slit-like discharge opening in the lower end thereof, comprising a cleaning tank which is filled with a cleaning liquid, and two cylindrical long-length brushes which are disposed within the cleaning tank so that the axes of the brushes are parallel to the slit-like discharge opening, wherein the two long-length brushes are located in the position where the hair structures thereof are in contact with each other so as to sandwich the lower end of the nozzle therebetween, and wherein the length of each long-length brush is substantially the same as the length of the nozzle, and each brush is rotatable around the axis thereof and can be reciprocated in the horizontal direction perpendicular to the axis and also in the vertical direction.

Since the two long-length brushes are rotated and moved in the vertical direction and the horizontal direction in a state where the lower end of the nozzle to be cleaned is sandwiched between the two long-length brushes, it is possible to more efficiently clean both side surfaces of the discharge opening of the slit nozzle as well as the discharge opening itself with the long-length brush always being in contact in the best position. Specifically, in order to clean both side surfaces of the discharge opening, the long-length brush is moved in the horizontal direction and then elevated.

In addition, by providing a brush cleaning means for scraping a material attached to the long-length brush itself within the cleaning tank, it is possible to always keep the long-length brush clean.

### BRIEF DESCRIPTION OF THE DRAWINGS

FIG. 1 shows the movement of a cleaning apparatus for a nozzle according to a first embodiment of the present invention;

FIG. 2 shows a cleaned area of the nozzle depending on the arrangement angle of the hair structure of the long-length brush, specifically, FIG. 2(a) shows a case where the arrangement direction is perpendicular to the portion of the nozzle to be cleaned and FIG. 2(b) shows a case where the arrangement direction is oblique with respect to the portion of the nozzle to be cleaned;

FIG. 3 is a diagram showing the structure of the movement of the long-length brush for cleaning a slit nozzle seen from the side;

FIG. 4 is a diagram showing the structure of the movement of the long-length brush for cleaning a slit nozzle seen from the cross-section; and

FIG. 5 shows a cleaning apparatus for a nozzle according to a second embodiment of the present invention.

### DETAILED DESCRIPTION OF THE PREFERRED EMBODIMENTS

Hereinafter, embodiments according to the present invention will be explained with reference to the attached drawings.

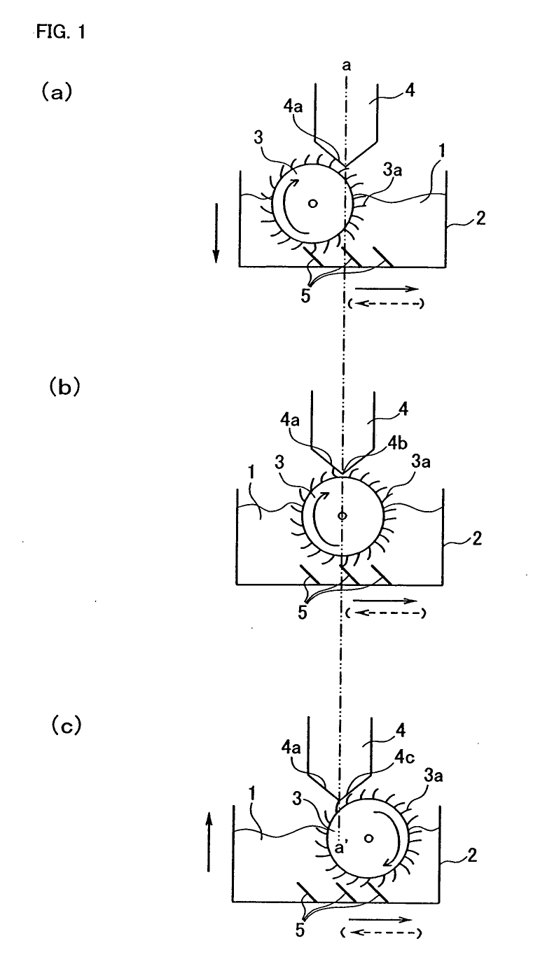

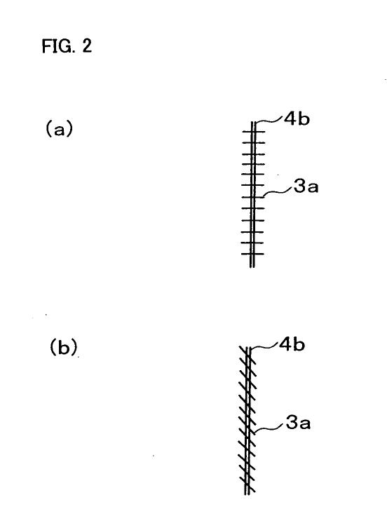

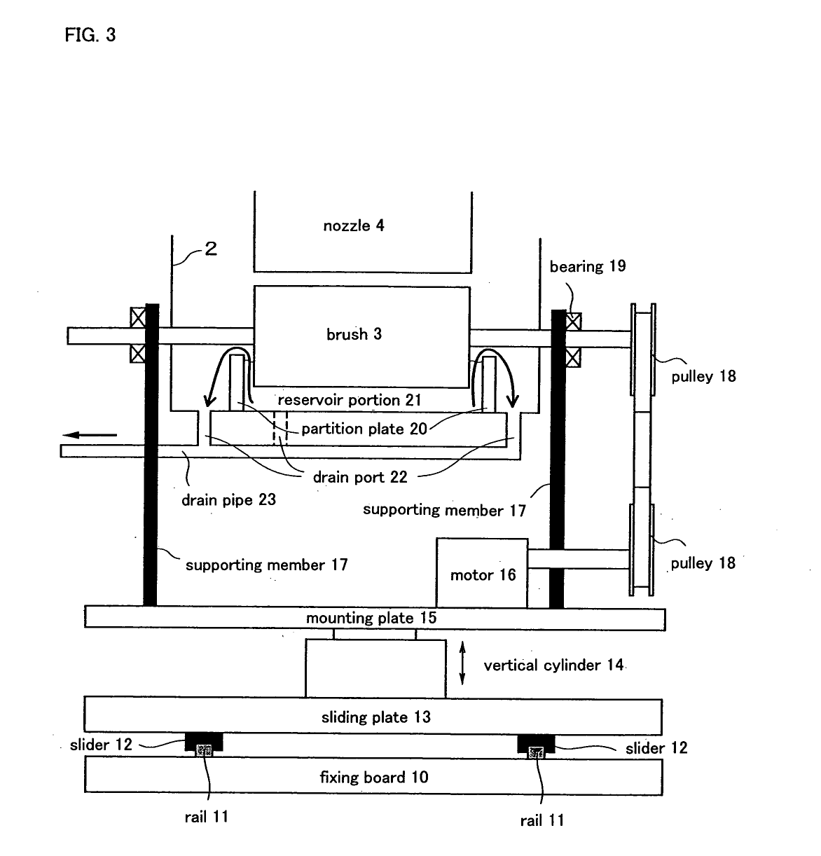

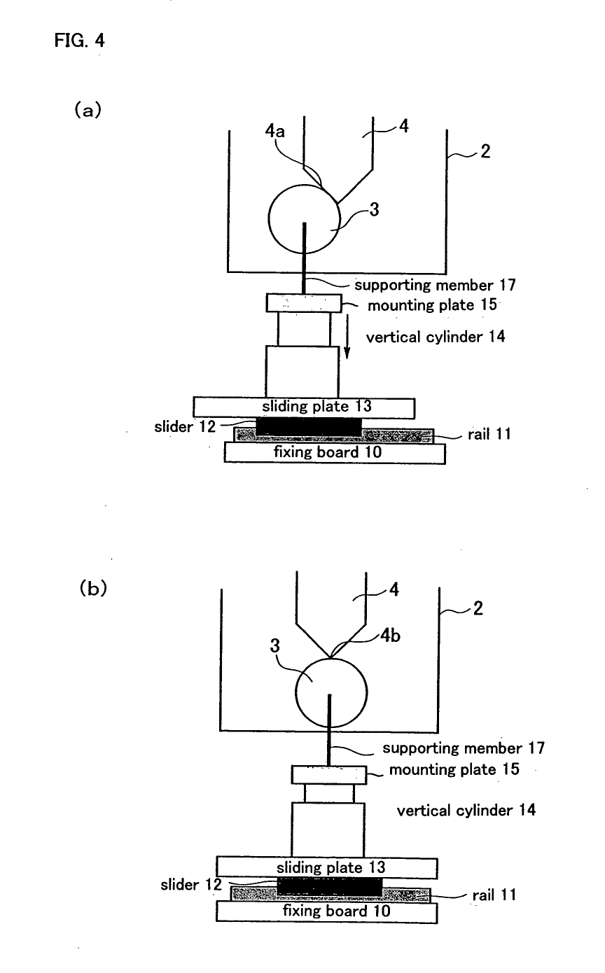

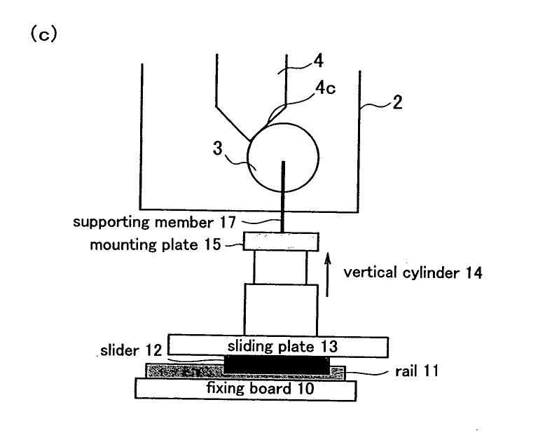

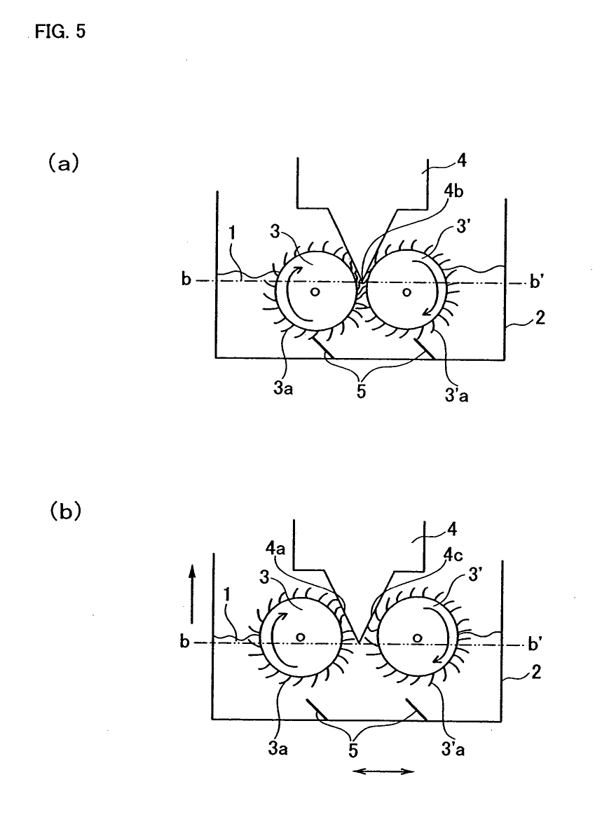

FIGS. 1(a)-(c) show the movement of a cleaning apparatus for a nozzle according to a first embodiment of the present invention, FIGS. 2(a) and (b) show a cleaned area of the nozzle depending on the arrangement angle of the hair structure of the long-length brush, FIG. 3 is a cross-sectional view of an example of the cleaning apparatus for a nozzle according to the first embodiment of the present invention, FIGS. 4(a)-(c) are diagrams showing the structure of the movement of the long-length brush for cleaning a slit nozzle seen from the cross-section, and FIG. 5 shows a cleaning apparatus for a nozzle according to a second embodiment of the present invention.

As shown in FIG. 1, a cylindrical long-length brush 3 is disposed to be rotatable within a cleaning tank 2 which is a reservoir for a cleaning liquid 1, and a slit nozzle 4 is positioned above the long-length brush 3 so as to be movable in the vertical direction. Incidentally, line a-a′ in FIG. 1 is an imaginary line for showing the reference position.

The axis of the long-length brush 3 is parallel to a slit-like discharge opening which is located in the lower end of the slit nozzle 4. The long-length brush 3 is rotatable around the axis, and also the long-length brush 3 can be reciprocated in the horizontal direction perpendicular to the axis and in the vertical direction.

The long-length brush 3 is made of stainless steel, aluminum, titanium or the like. Regarding the size of the long-length brush 3, the diameter is 30-100 mm, the length is set to be slightly greater than the longitudinal length of the slit nozzle 4, and the distance to the discharge opening of the slit nozzle 4 becomes 25-300 μm during cleaning.

The arrangement direction of the hair structure of the long-length brush 3 is oblique as shown in FIG. 2(b). By doing so, the cleaned area becomes greater compared to a case where the arrangement direction is perpendicular to the lower end of the slit nozzle to be cleaned (that is, the discharge opening and both side surfaces thereof), and cleaning efficiency is improved. Preferably, the flow direction of the hair structure 3a of the long-length brush 3 is set to be the same as the rotation direction of the long-length brush 3.

Also, three combs 5 as a brush cleaning means are provided in the bottom of the cleaning tank 2 as shown in FIG. 1 in order to scrape dirt attached to the hair structure of the long-length brush 3. The number of combs 5 may be changed as needed, and also the material and the shape are not limited to particular ones.

The amount of the cleaning liquid 1 can be changed freely. The whole brush 3 may be immersed into the cleaning liquid, or almost half of the long-length brush 3 may be immersed into the cleaning liquid. That is, the amount of the cleaning liquid 1 can be set optionally depending on the degree of cleaning.

FIG. 3 shows the structure in which the long-length brush 3 is moved while being supported by a supporting member. Specifically, a sliding plate 13 is engaged into rails 11 on a fixing board 10 via sliders 12, and the sliding plate 13 is slid back and forth by driving a cylinder or the like which is not shown in the drawing. For example, when the sliding plate 13 is moved from the forward side to the back side, the long-length brush 3 is moved from the forward side which is oblique to the slit nozzle 4 to the back side which is oblique to the slit nozzle 4 via the tip end of the slit nozzle 4.

A vertical cylinder 14 is disposed on the sliding plate 13, and the vertical cylinder 14 elevates and lowers a mounting plate 15. The long-length brush 3 is moved in the vertical direction with respect to the slit nozzle 4 by the mounting plate 15. A motor 16 and two supporting members 17 are fixed onto the mounting plate 15. The supporting members 17 support the long-length brush 3, and the motor 16 rotates the long-length brush 3 in an optional direction via pulleys 18 and bearings 19.

In addition, as shown in FIG. 3, two partition plates 20 are provided in the bottom of the cleaning tank 2, and the area surrounded by the partition plates 20 forms a reservoir portion for a cleaning liquid 21 to immerse the long-length brush 3 therein. In a case where the cleaning liquid overflows the partition plates 20, the liquid passes through drain ports 22 which are also provided in the bottom of the cleaning tank 2, and is discharged from a drain pipe 23. If needed, another drain port 22 may be provided in the bottom of the reservoir portion for a cleaning liquid 21 so that cleaning can be conducted to the reservoir portion for a cleaning liquid 21.

In operation, as shown in FIG. 1, the long-length brush 3 is moved downward and rightward while being rotated clockwise, and thereby the left side 4a of the lower end of the silt nozzle 4 and the discharge opening 4b of the slit nozzle 4 are cleaned by the long-length brush 3 in a state where the long-length brush 3 keeps in contact with the lower end of the slit nozzle 4. Next, the long-length brush 3 is moved upward and rightward, and thereby the right side 4c of the lower end of the slit nozzle 4 is cleaned by the long-length brush 3. In the process of the above-mentioned cleaning, the combs 5 scrapes dirt attached to the hair structure 3a of the long-length brush 3. Alternatively, cleaning may be conducted to the right side 4c of the lower end of the slit nozzle 4, the discharge opening 4b of the slit nozzle 4, and the left side 4a of the lower end of the silt nozzle 4 in this order.

More specifically, as shown in FIG. 4(a), after the long-length brush 3 is rotated in advance, the sliders are moved to the right, and at the same time, the hair structure 3a (not shown in FIG. 4) of the long-length brush 3 is lowered by the vertical cylinder to come into contact with the left side 4a of the lower end of the silt nozzle 4, so that the left side 4a of the lower end of the silt nozzle 4 is cleaned. Next, as shown in FIG. 4(b), the sliders are stopped at the discharge opening 4b of the slit nozzle 4, the vertical cylinder is also stopped in the lowest position, and the discharge opening 4b of the slit nozzle 4 is cleaned by the long-length brush 3. Next, as shown in FIG. 4(c), the sliders are moved to the right again, and at the same time, the hair structure 3a (not shown in FIG. 4) of the long-length brush 3 is elevated by the vertical cylinder to come into contact with the right side 4c of the lower end of the silt nozzle 4, so that the right side 4c of the lower end of the silt nozzle 4 is cleaned. The long-length brush 3 is always rotated during the above-mentioned cleaning. It should be noted that the starting position of cleaning is optional, and the order of cleaning is not limited to the above. For example, the discharge opening 4b of the slit nozzle 4 may be cleaned first, and thereafter the long-length brush 3 may be moved to the left and the right. Or, cleaning may be started from the right side 4c and end at the left side 4a. Also, the reciprocating movement of the long-length brush 3 may be one cycle or a plurality of cycles.

FIG. 5 shows a cleaning apparatus for a nozzle according to a second embodiment of the present invention. In FIG. 5, the same elements as in FIG. 1 have the same reference number, and the explanations thereof are omitted. In the embodiment shown in FIG. 5, the slit nozzle 4 is cleaned by using two long-length brushes 3, 3′. The long-length brushes 3, 3′ are rotated clockwise, and wrap the whole lower end of the slit nozzle 4 in a state of keeping in contact with the lower end of the slit nozzle 4. In this state, the discharge opening 4b of the silt nozzle 4 is cleaned by the long-length brushes 3, 3′, and thereafter, the left side 4a and the right side 4c are cleaned by gradually moving the long-length brushes 3, 3′ upward, leftward and rightward. It is also possible to clean the left side 4a and the right side 4c first by moving the long-length brushes 3, 3′ downward, leftward and rightward, and then clean the discharge opening 4b of the slit nozzle 4. Incidentally, line b-b′ in FIG. 5 is an imaginary line for showing the reference position. Although both of the long-length brushes 3, 3′ are rotated clockwise in the above-mentioned embodiment, it is possible to rotate the long-length brush 3 clockwise and the long-length brush 3′ counterclockwise.

As is explained in the above, according to the present invention, since the long-length brush is moved in the vertical direction and the horizontal direction while being rotated in a state of being in contact with the lower end of the nozzle to be cleaned, it is possible to clean both side surfaces of the discharge opening of the slit nozzle as well as the discharge opening itself with the long-length brush always being in contact in the best position. Specifically, in order to clean both side surfaces of the discharge opening, the long-length brush is moved in the horizontal direction and then elevated.

By adjusting the arrangement direction of the hair structure of the long-length brush so as to be in contact with the lower end of the nozzle to be cleaned in an oblique direction, the contact area of the hair structure with the portion of the nozzle to be cleaned becomes large, and thereby cleaning efficiency can be improved.

Since the two long-length brushes are rotated and moved in the vertical direction and the horizontal direction in a state where the lower end of the nozzle to be cleaned is sandwiched between the two long-length brushes, it is possible to more efficiently clean both side surfaces of the discharge opening of the slit nozzle as well as the discharge opening itself with the long-length brush always being in contact in the best position. Specifically, in order to clean both side surfaces of the discharge opening, the long-length brush is moved in the horizontal direction and then elevated.

In addition, by providing the brush cleaning means for scraping a material attached to the long-length brush itself within the cleaning tank, it is possible to always keep the long-length brush clean.

What is claimed is:

1. A cleaning apparatus for a nozzle having a slit-like discharge opening in the lower end thereof, comprising:
a cleaning tank which is filled with a cleaning liquid; and
a cylindrical long-length brush which is disposed within said cleaning tank so that the axis of said brush is parallel to said slit-like discharge opening,
wherein the length of said long-length brush is substantially the same as the length of said nozzle, and said brush is rotatable around the axis of the brush and can be reciprocated in the horizontal direction perpendicular to the axis and also in the vertical direction.

2. The cleaning apparatus for a nozzle according to claim 1, wherein the hair structure of the long-length brush is arranged obliquely with respect to the axis of the brush so as to be in contact with the lower end of the nozzle to be cleaned in an oblique direction.

3. A cleaning apparatus for a nozzle having a slit-like discharge opening in the lower end thereof, comprising:
a cleaning tank which is filled with a cleaning liquid; and
two cylindrical long-length brushes which are disposed within said cleaning tank so that the axes of said brushes are parallel to the slit-like discharge opening,
wherein said two long-length brushes are located in a position where the hair structures thereof are in contact with each other so as to sandwich the lower end of said nozzle therebetween, and
wherein the length of each long-length brush is substantially the same as the length of said nozzle, and each brush is rotatable around the axis of the brush and can be reciprocated in the horizontal direction perpendicular to the axis and also in the vertical direction.

4. The cleaning apparatus for a nozzle according to any one of claims 1-3, wherein a brush cleaning means for scraping a material attached to the long-length brush is provided within the cleaning tank.
